(19) United States
(12) Patent Application Publication
(10) Pub. No.: US 2020/0110421 A1
(43) Pub. Date: Apr. 9, 2020

(54) AUTOMATED GUIDED VEHICLE

(71) Applicant: TECO ELECTRIC & MACHINERY CO., LTD., Taipei City (TW)

(72) Inventors: Chia-Jen LIN, Taipei City (TW); Bo-Syun LAI, Taipei City (TW); Shih-Chang CHEU, Taipei City (TW)

(21) Appl. No.: 16/173,396

(22) Filed: Oct. 29, 2018

(30) Foreign Application Priority Data
Oct. 5, 2018 (TW) 107135286

(51) Int. Cl. G05D 1/02; G05D 1/00; G05B 19/418; G06F 17/30

(52) U.S. Cl. CPC G05D 1/0274; G05D 1/0088; G05D 1/0229; G05D 2201/02; G06F 17/30241; G05D 1/0223; G05D 1/0219; G05B 19/41895

(57) ABSTRACT

An automated guided vehicle, utilized to move within a working area, includes a regional mapping module, a local mapping module, a modified mapping module, and a guiding module. The regional mapping module is to generate a regional map of the working area. The local mapping module is to generate a local map of a surrounding area of the automated guided vehicle. The modified mapping module is to transform the regional map into a modified map. The guiding module is to guide the automated guided vehicle to displace from a present position to a target position.

### BACKGROUND OF THE INVENTION

### 1. Field of the Invention

The invention relates to an automated guided vehicle, and more particularly to the automated guided vehicle that can transform a regional map into a modified map with narrowed driveways.

### 2. Description of the Prior Art

With the progress in artificial intelligence (AI), more and more moving or service robots have been developed, and some of them in various fields have presented to the marketplace. For example, dining robots have served in some specific restaurants, financial-service robots can be seen in many banks, and luggage-handling robots are recently introduced to serve in some airports in the states.

Except for human-like robots, automated guided vehicles (AGV), cleaning robots and the like are also benefited from the progress in the artificial intelligence.

However, the aforesaid products related to the artificial intelligence are still far from a stage of self teaching or thinking. In the art, the human-like robots can only respond to user's instructions, and so are the automated guided vehicle and the cleaning robots. In particular, some of the automated guided vehicles may even need special rails to follow. In addition, since the working ambience varies all the time, such as unexpected human cross and displaced obstacles, possible incidences to damage the robot or the automated guided vehicle could occur anytime if the robot or the automated guided vehicle isn't defaulted with corresponding reaction setup against those situations.

### SUMMARY OF THE INVENTION

Accordingly, in the art, the automated guided vehicle only responds to user's instructions, needs special rails to follow, and works in an unstable environment, thus possible damage could happen to the automated guided vehicle if none of corresponding reaction setup against unexpected events is provided. It is an object of the present invention to provide an automated guided vehicle that can perform self calibration in correspondence with variations in the working area.

In the present invention, the automated guided vehicle, moving within a working area, includes a regional mapping module, a local mapping module, a modified mapping module and a guiding module.

The regional mapping module, for scanning the working area upon when the automated guided vehicle is moving within the working area, is further to generate a regional map of the working area. The regional map is consisted of at least one obstacle and at least one accessible region.

The local mapping module, connected communicatively with the regional mapping module, is to scan an instant surrounding region of the automated guided vehicle in a real-time manner upon when the automated guided vehicle is moving in the working area, further to generate a local map, and to compare the local map with the regional map so as to verify a present position of the automated guided vehicle.

The modified mapping module, connected communicatively with the regional mapping module, includes an accessible-region width-calculating unit, a scale-determining unit and an modified-map generating unit. The accessible-region width-calculating unit is to compute a plurality of accessible sectional widths corresponding to a plurality of accessible sections within the at least one accessible region. The scale-determining unit is to evaluate the plurality of accessible sectional widths to further derive a plurality of narrowed accessible sectional widths with respect to the plurality of accessible sections, in which, the wider one of the plurality of accessible sectional widths is, the corresponding narrowed accessible sectional width would be. The modified-map generating unit is to amend the plurality of accessible sections on the regional map into a plurality of narrowed accessible sections according to the plurality of narrowed accessible sectional widths, so that the regional map is transformed into a modified map.

The guiding module, connected communicatively with the modified mapping module and the local mapping module, is to guide the automated guided vehicle to pass through the plurality of narrowed accessible sections, after the present position and a target position are confirmed.

In one embodiment of the present invention, the guiding module includes an optimal-route planning unit for planning an optimal route for the automated guided vehicle to displace within the at least one narrowed accessible region, and the optimal route is one of a time-optimal route and a safety-optimal route.

In one embodiment of the present invention, the automated guided vehicle further includes a speed-modulating module connected communicatively with the modified mapping module and the guiding module. The speed-modulating module is to generate a plurality of moving speeds with respect to the plurality of narrowed accessible sectional widths so as to control the automated guided vehicle to travel in the at least one narrowed accessible region at the moving speed corresponding to the respective narrowed accessible sectional width.

In one embodiment of the present invention, the regional mapping module includes a regional-map scanning unit for scanning the working area.

In one embodiment of the present invention, the regional-map scanning unit is a laser scan unit.

In one embodiment of the present invention, the local mapping module includes a local-map scanning unit for scanning the instant surrounding region in a real-time manner.

In one embodiment of the present invention, the local-map scanning unit is a laser scan unit.

In one embodiment of the present invention, the local mapping module includes a map-to-map comparing unit for comparing a plurality of local characteristic points on the local map with a plurality of regional characteristic points on the regional map, so that, if the plurality of local characteristic points match the plurality of regional characteristic points, the present position of the automated guided vehicle is confirmed.

In one embodiment of the present invention, in the case that one of the plurality of accessible sectional widths is larger than a predetermined width more than a width of the automated guided vehicle, the scale-determining unit assigns a predetermined narrowed width ranging 1/1000˜½ width of the automated guided vehicle to be removed from each one side of the one of the plurality of accessible sectional widths so as to form correspondingly one of the plurality of narrowed accessible sectional widths.

In one embodiment of the present invention, the automated guided vehicle further includes an obstacle height-determining unit for capturing at least an image of a specific obstacle out of the at least one obstacle and further evaluating a height of the specific obstacle. The obstacle height-determining unit is communicatively connected with the guiding module, the regional mapping module and the local mapping module. When the obstacle height-determining unit judges the specific obstacle to have a height lower than a predetermined traversable height for the automated guided vehicle, the obstacle height-determining unit defines the specific obstacle as a traversable obstacle and an area occupied by the specific obstacle as an extended accessible region.

As stated, the automated guided vehicle provided by present invention transforms the regional map into the modified map, such that possibility of collisions between the automated guided vehicle and the obstacles can be significantly reduced.

All these objects are achieved by the automated guided vehicle described below.

### BRIEF DESCRIPTION OF THE DRAWINGS

The present invention will now be specified with reference to its preferred embodiment illustrated in the drawings, in which:

FIG. 1 is a schematic block view of a first embodiment of the automated guided vehicle in accordance with the present invention;

FIG. 2 is a schematic view of a regional map of a working area for the automated guided vehicle of FIG. 1;

FIG. 3 is a schematic view of a modified map for FIG. 2;

FIG. 4 is a schematic block view of a second embodiment of the automated guided vehicle in accordance with the present invention;

FIG. 5 is a schematic view of a modified map for a regional map of a working area for the automated guided vehicle of FIG. 4; and

FIG. 5A is a schematic view of another modified map for the regional map of the working area for the automated guided vehicle of FIG. 4.

### DESCRIPTION OF THE PREFERRED EMBODIMENT

The invention disclosed herein is directed to an automated guided vehicle. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

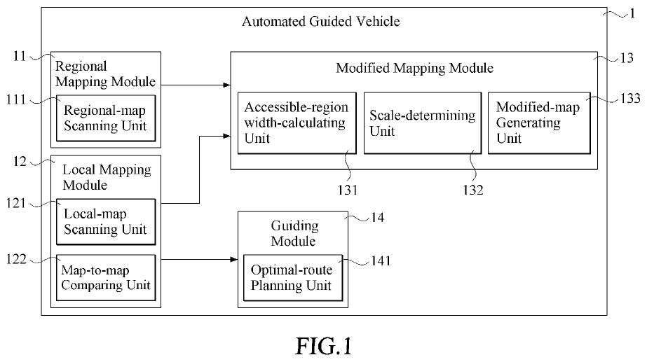

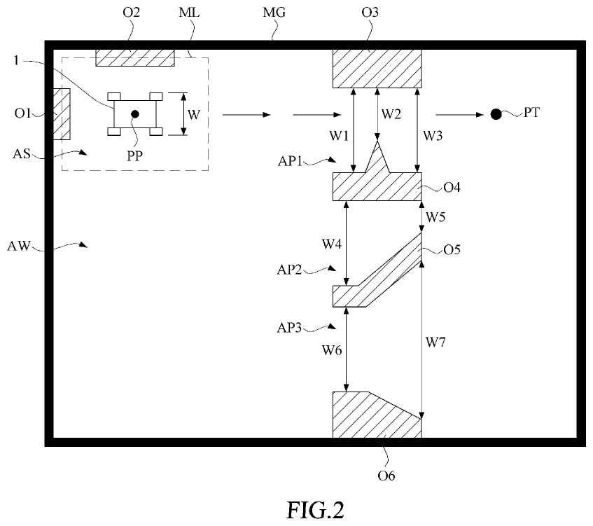

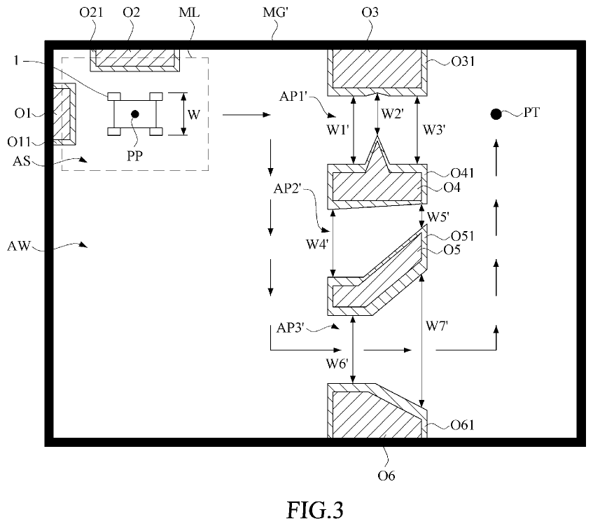

Refer now to FIG. 1 through FIG. 3; where FIG. 1 is a schematic block view of a first embodiment of the automated guided vehicle in accordance with the present invention, FIG. 2 is a schematic view of a regional map of a working area for the automated guided vehicle of FIG. 1, and FIG. 3 is a schematic view of a modified map for FIG. 2. As shown, the automated guided vehicle 1 with a width W, located in a working area AW, includes a regional mapping module 11, a local mapping module 12, a modified mapping module 13 and a guiding module 14.

The regional mapping module 11 includes a regional-map scanning unit 111 for scanning the entire working area AW upon when the automated guided vehicle 1 is moving within the working area AW, and further for generating a regional map MG according to the working area AW. As shown, the regional map MG is consisted of a plurality of obstacles O1, O2, O3, O4, O5, O6 and an accessible region, where the accessible region is defined as the area of the regional map MG other than the plurality of obstacles O1, O2, O3, O4, O5, O6.

In this embodiment, the regional-map scanning unit 111 is a laser scan unit that can provide a faster scan speed and a broader scan coverage. By computing a time difference from the emitting time to the receiving time of the laser beam, then a corresponding distance between the obstacle reflecting the laser beam and the automated guided vehicle 1 can be obtained. If no reflected laser beam is received, then it implies that no obstacle exists in the direction corresponding to the the instant laser beam. However, in some other embodiments of the present invention, the regional-map scanning unit 111 can be an ultrasonic scanning unit, a device applying the signal strength ratio (SSR) technique, or any other device applying non-contact distance-measuring means.

The local mapping module 12, connected communicatively with the regional mapping module 11, includes a local-map scanning unit 121 and a map-to-map comparing unit 122. The local-map scanning unit 121 is to scan an instant surrounding region AS of the automated guided vehicle 1 in a real-time manner upon when the automated guided vehicle 1 is moving in the working area AW. Accordingly, a corresponding local map ML can be generated. In the present invention, the same or similar techniques and algorithms to generate a map are adopted for both the regional mapping module 11 and the local mapping module 12. The map-to-map comparing unit 122, for comparing the local map ML with the regional map MG, is to verify a present position PP of the automated guided vehicle 1. More precisely, while in performing the map-to-map comparing unit 122, a plurality of local characteristic points on the local map ML are individually compared with another plurality of regional characteristic points on the regional map MG, the obstacles O1 and O2 for example. If the local characteristic points match the regional characteristic points, then the present position PP of the automated guided vehicle 1 can be confirmed. In another embodiment of the present invention, the map-to-map comparing unit 122 can adopt a Bluetooth multiple positioning technique.

The modified mapping module 13, connected communicatively with the regional mapping module 11, includes an accessible-region width-calculating unit 131, a scale-determining unit 132 and an modified-map generating unit 133. The accessible-region width-calculating unit 131 is to compute a plurality of accessible sectional widths W1, W2, W3, W4, W5, W6 and W7 corresponding to a plurality of accessible sections AP1, AP2 and AP3 within the accessible region. The scale-determining unit 132 is to evaluate these accessible sectional widths W1, W2, W3, W4, W5, W6 and W7 to further derive respectively a plurality of narrowed accessible sectional widths W1′, W2′, W3′, W4′, W5′, W6′ and W7′ with respect to the narrowed accessible sections AP1′, AP2′ and AP3′. In general, the wider the accessible sectional width W1, W2, W3, W4, W5, W6 or W7 is, the larger the corresponding narrowed accessible sectional width W1′, W2′, W3′, W4′, W5′, W6′ or W7′ would be. In particular, in this embodiment, each of the narrowed accessible sectional widths W1′, W2′, W3′, W4′, W5′, W6′ and W7′ is 80% of the corresponding accessible sectional width W1, W2, W3, W4, W5, W6 or W7. In an exemplary embodiment, the individual narrowed accessible sectional width W1′, W2′, W3′, W4′, W5′, W6′ or W7′ is obtained by cutting 10% of the corresponding accessible sectional width W1, W2, W3, W4, W5, W6 or W7 at each side of the respective accessible section AP1, AP2 or AP3. The modified-map generating unit 133 amends the accessible sections AP1, AP2 and AP3 on the regional map MG into the corresponding narrowed accessible sections AP1′, AP2′ and AP3′ according to the narrowed accessible sectional widths W1′, W2′, W3′, W4′, W5′, W6′ and W7′ obtained by the scale-determining unit 132. Thereupon, the accessible region AW can be amended into a corresponding contracted accessible region. Thus, the regional map MG can be transformed into a corresponding modified map MG′.

The purpose to derive the modified map MG′ by transforming the regional map MG is to reduce a risk of the automated guided vehicle 1 colliding any of the obstacles O1, O2, O3, O4, O5, O6 mainly caused by inevitable computation lags in position judging, scanning and/or any processing. Simply to say, if a feasible route is planned on the modified map MG′ for the automated guided vehicle 1 to pass through, then the automated guided vehicle 1 would definitely go through the working area AW on the regional map MG without any collision. It is understood that, on the regional map MG, a narrower driveway between two neighboring obstacles to just pass the automated guided vehicle 1 would be quite possible to result in an unexpected collision for the passing automated guided vehicle 1. Namely, a path including a narrower driveway planned on the regional map MG might not be a feasible route for the automated guided vehicle 1 planned on the modified map MG′. Upon such an arrangement, the possibility of collisions between the automated guided vehicle 1 and any of the obstacles can be significantly reduced.

In other words, by transforming the regional map MG into the modified map MG′, the accessible sectional widths W1, W2, W3, W4, W5, W6 and W7 would be revised individually into the narrowed accessible sectional widths W1′, W2′, W3′, W4′, W5′, W6′ and W7′, respectively. Preferably, each of the narrowed accessible sectional widths W1′, W2′, W3′, W4′, W5′, W6′ and W7′ can be obtained by scaling down the corresponding accessible sectional width W1, W2, W3, W4, W5, W6 or W7. In this embodiment, each of the narrowed accessible sectional widths W1′, W2′, W3′, W4′, W5′, W6′ and W7 has 80% of the corresponding accessible sectional width W1, W2, W3, W4, W5, W6 or W7. Equally, it can be realized that the aforesaid transformation from the regional map MG into the modified map MG′ is equivalently obtained by adding expanding rims O11, O21, O31, O41, O51, O61 to the obstacles O1, O2, O3, O4, O5, O6, respectively.

Further, uniquely as shown in the figure, a descending order for the narrowed accessible sectional widths is the order of W7′, W6′, W4′, W3′, W1′, W2′, W5′, in which W6′=W4′=W3′=W1′. In the present invention, the modified mapping module 13 can be a chip, a processor, a controller or any the like that can calculate widths of the individual expanding rims in a software or hardware manner.

The guiding module 14, connected communicatively with the modified mapping module 13 and the local mapping module 12, is to guide the automated guided vehicle 1 to pass through the narrowed accessible sections AP1′, AP2′ and AP3′ on the modified map MG′, after the present position PP and a target position PT are confirmed. In the present invention, the guiding module 14 can be a controller, a processor or any device that can perform guiding to avoid collisions in a software or hardware manner.

In this embodiment, the guiding module 14 includes an optimal-route planning unit 141 for planning an optimal route for the automated guided vehicle 1 to displace from the present position PP to the target position PT. According to the present invention, the optimal route can be a time-optimal route, or a safety-optimal route.

In the present invention, the time-optimal route is defined as the shortest path between the present position PP and the target position PT. In the embodiment shown in FIG. 3, the time-optimal route is a path through the narrowed accessible section AP1′. On the other hand, the safety-optimal route is defined as the path between the present position PP and the target position PT that provides a largest safest narrowed accessible sectional width among the narrowed accessible sections for the automated guided vehicle 1 to pass through. A candidate safest narrowed accessible sectional width for each the narrowed accessible section is defined as the smallest narrowed accessible sectional width throughout the corresponding narrowed accessible section. As shown in FIG. 3, the candidate safest accessible sectional width of the narrowed accessible section AP1′ is the narrowed accessible sectional width W2′, that of the narrowed accessible section AP2′ is the narrowed accessible sectional width W5′, and that of the narrowed accessible section AP3′ is the narrowed accessible sectional width W6′. Since the largest safest accessible sectional width among the narrowed accessible sections AP1′, AP2′ and AP3′ is the narrowed accessible sectional width W6′ at the narrowed accessible sections AP3′, thus, in this embodiment, the safety-optimal route is the path passing through the narrowed accessible section AP3′. Herein, the safety is defined with the smallest possibility of collisions between the automated guided vehicle 1 and the obstacles. Since the narrowed accessible sectional width W6′ is larger than any of the narrowed accessible sectional widths W2′ and W5′, it implies that the narrowed accessible section AP3′ is the widest section among all three narrowed accessible sections in FIG. 3. By mapping the narrowed accessible region AP3′ back to the accessible section AP3, the widths of the accessible section AP3 on the regional map MG would be expanded, and thus the possibility of collisions for the automated guided vehicle 1 to pass through the accessible section AP3 (corresponding to the narrowed accessible section AP3′), while traveling in the working area AW, would be comparatively minimal.

In addition, it is seen that the narrowed accessible sectional width W5′ in the narrowed accessible section AP2′ is less than the width of vehicle W. Thus, the guiding module 14 would never lead the automated guided vehicle 1 to pass the narrowed accessible region AP2′.

In this embodiment, the scale-determining unit 132 is used for calculating the narrowed accessible sectional widths, based on the corresponding accessible sectional widths. In the case that a calculated width to be removed from one side of the accessible sectional width is larger than the width of vehicle W, it implies that the instant narrowed accessible sectional width is mapped to an accessible section that provides an extreme wide accessible sectional width. Thus, if a transformation is regularly performed upon this extreme wide accessible sectional width, then the derived modified map MG′ would show possible distortion with respect to the related obstacles. As a result, the planning or scanning of the feasible route to travel the automated guided vehicle 1 would be affected. Hence, if the aforesaid situation is met, the scale-determining unit 132 would assign a predetermined narrowed width to each side of the extreme wide accessible sectional width. Preferably, the predetermined narrowed width ranges from 1/1000 to ½ of the width of vehicle W. In some other embodiments of the present invention, the scale-determining unit 132 can pair the guiding module 14 to calculate the narrowed accessible sectional width. In the case that an accessible region is out of the planned route proposed by the guiding module 14, the scale-determining unit 132 would assign the predetermined narrowed width to the accessible region, such that less distortion would be achieved during the transformation from MG to MG′. Preferably, the predetermined narrowed width can be 1/1000 width of vehicle W for the accessible region out of the planned route proposed by the guiding module 14. Thus, such an alternative would prevent the modified map from too much distortion with respect to the regional map. In addition, by having the scale-determining unit 132 to assign directly the predetermined narrowed width to obtain a calculated narrowed accessible sectional width without tedious calculations, the entire calculation efficiency of the automated guided vehicle 1 would be substantially increased.

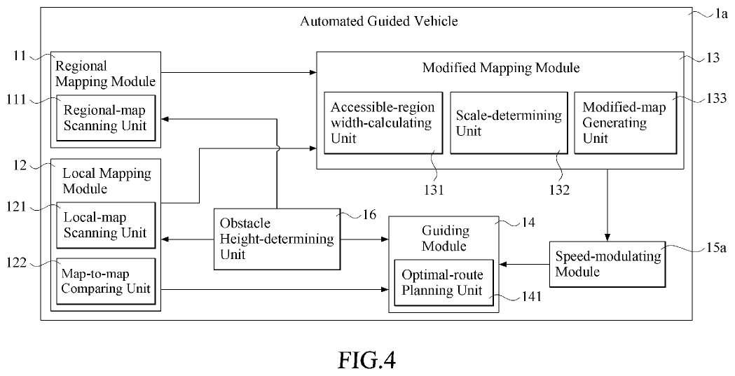

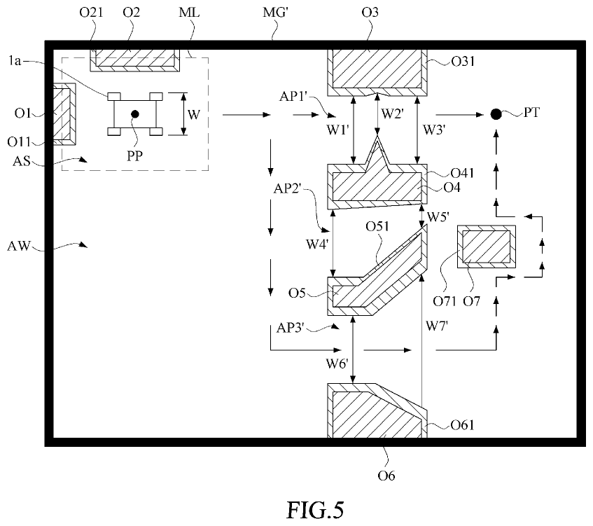

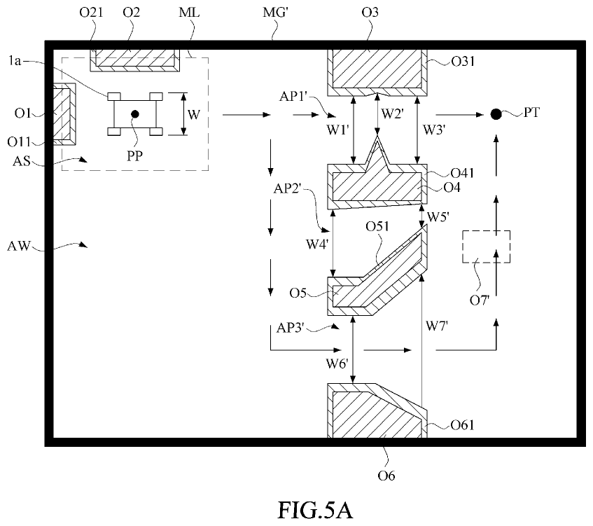

Then, refer now to FIG. 4 through FIG. 5A; where FIG. 4 is a schematic block view of a second embodiment of the automated guided vehicle in accordance with the present invention, FIG. 5 is a schematic view of a modified map of a working area for the automated guided vehicle of FIG. 4, and FIG. 5A is a schematic view of another modified map for the regional map of the working area for the automated guided vehicle of FIG. 4. As shown, this second embodiment of the automated guided vehicle 1a is largely resembled to the first embodiment 1 thereof. The major difference in between is that, in this second embodiment, the automated guided vehicle 1a further includes a speed-modulating module 15a.

Just like a normal driving, the speed of vehicle is quite related to the roadside and road situations. For example, the driving speed would be lower while driving on a narrow road. On the other hand, a higher driving speed would be determined while driving on a wider road.

The speed-modulating module 15a would regulate a moving speed of the automated guided vehicle 1a according to the width or the narrowed width of the narrowed accessible section. Generally, the larger the narrowed accessible sectional width is, the larger the accessible sectional width on the regional map MG would be, and the faster the moving speed of the automated guided vehicle 1a can be. Thus, a wider narrowed accessible sectional width would imply that the speed-modulating module 15a would propose a faster moving speed. Equally, a smaller narrowed accessible sectional width would imply a slower moving speed determined by the speed-modulating module 15a.

As shown in FIG. 5, as the automated guided vehicle 1a passes through the narrowed accessible section AP1′, since the narrowed accessible section AP1′ has narrowed accessible sectional widths W1′, W2′ and W3′, in which W3′=W1′ and W3′>W2′, thus the moving speed of the automated guided vehicle 1a would be larger while in passing the narrowed accessible sectional widths W1 ‘and W3’. Similarly, the moving speed of the automated guided vehicle 1a to pass the narrowed accessible sectional width W7′ would be larger than that to pass the narrowed accessible sectional width W6′. By taking the moving speeds into consideration, the traveling time from the present position PP to the target position PT on each feasible route can be calculated, and thus the time-optimal route can be determined.

While in passing a narrower narrowed accessible section (i.e., with a smaller narrowed accessible sectional width), the moving speed of the automated guided vehicle 1a would be slower, such that errors caused by the scan time upon the map or the calculation time to obtain the narrowed accessible sectional width can be avoided. Also, the possibility of collisions between the automated guided vehicle 1a and the obstacles can be further reduced.

Preferably, the automated guided vehicle 1a of the present invention may further include an obstacle height-determining unit 16 for capturing at least an image of a specific obstacle (generally the nearest obstacle) and further evaluating a height (generally the maximal height) of the specific obstacle based on the captured image. If the obstacle height-determining unit 16 judges that the specific obstacle has a height less than a predetermined traversable height for the automated guided vehicle 1a, then the automated guided vehicle 1a can be proposed to run directly over the specific obstacle without any safety problem. Namely, in this circumstance, the obstacle height-determining unit 16 defines the specific obstacle as a traversable obstacle, and the area occupied by the specific obstacle is treated as an extended accessible region. In the present invention, the predetermined traversable height is defined as a height that the automated guided vehicle 1a can run over directly without a jeopardy in driving safety or a risk in damaging the vehicle 1a. Practically, the predetermined traversable height can be a half, one third, or a quarter of the height of the automated guided vehicle 1a.

The obstacle height-determining unit 16 can utilize a laser means to realize the height of the obstacle, particularly by incorporating algorithms in trigonometric functions. In some other embodiments of the present invention, a built-in proportional rule can be also an alternative of the laser means to realize the height of the specific obstacle.

The obstacle height-determining unit 16 is communicatively connected with the guiding module 14, the regional mapping module 11 and the local mapping module 12. As obstacle height-determining unit 16 judges that a height of a specific obstacle is lower than the predetermined traversable height, corresponding signals are issued simultaneously to the guiding module 14, the regional mapping module 11 and the local mapping module 12, such that the regional mapping module 11 and the local mapping module 12 can proceed to add the extended accessible region into the corresponding regional and local maps. Thereupon, the guiding module 14 can consider to guide the automated guided vehicle 1a to go along a path within the extended accessible region and the narrowed accessible region.

The obstacle height-determining unit 16 may simply issue a signal to inform the guiding module 14 the existence of a specific obstacle having a height lower than the predetermined traversable height, such that the guiding module 14 can modify the planned route in time to guide the automated guided vehicle 1a to cut through the extended accessible region. In addition, the obstacle height-determining unit 16 can also issue signals only to the regional mapping module 11 and the local mapping module 12, such that the extended accessible region can be included into the regional and local maps. Thus, the modified mapping module 13 can transform the regional map furnished with the extended accessible region into a corresponding new modified map. Hence, the guiding module 14 can guide the automated guided vehicle 1a according to the new modified map.

As shown in FIG. 5, an obstacle O7 is furnished with an expanding rim O71. Thereupon, the automated guided vehicle would take a path to go around the obstacle O7 and the associated expanding rim O71. However, in FIG. 5A, after the obstacle height-determining unit 16 captures the image of the obstacle O7 and confirms that the height of the obstacle O7 is lower than the predetermined traversable height, then the obstacle O7 is attributed to be a traversable obstacle O7 having an extended accessible region O7′. Thus, the guiding module 14 can guide the automated guided vehicle 1a to pass through the extended accessible regionnO7′, such that the driving route can be slightly shortened. In addition, with the automated guided vehicle 1a is able to take a linear path across the obstacle O7, possibility of collisions caused by excessive detouring would be substantially reduced.

As described above, in comparison with the prior art, the automated guided vehicle provided by the present invention introduces a modified mapping module to transform the regional map into a modified map, such that, while the automated guided vehicle travels to pass through at least one narrowed accessible section within a modified accessible region on the modified map, possibility of collisions between the automated guided vehicle and the obstacles can be greatly reduced. Preferably, a speed-modulating module can be introduced to regulate the moving speed of the automated guided vehicle according to the narrowed accessible sectional width, thus the aforesaid possibility can be further reduced.

While the present invention has been particularly shown and described with reference to a preferred embodiment, it will be understood by those skilled in the art that various changes in form and detail may be without departing from the spirit and scope of the present invention.

What is claimed is:

1. An automated guided vehicle, moving within a working area, comprising:
a regional mapping module, being to scan the working area upon when the automated guided vehicle is moving within the working area, being further to generate a regional map of the working area, the regional map being consisted of at least one obstacle and at least one accessible region;
a local mapping module, connected communicatively with the regional mapping module, being to scan an instant surrounding region of the automated guided vehicle in a real-time manner upon when the automated guided vehicle is moving in the working area, being further to generate a local map, being to compare the local map with the regional map so as to verify a present position of the automated guided vehicle;
a modified mapping module, connected communicatively with the regional mapping module, including:
an accessible-region width-calculating unit, being to compute a plurality of accessible sectional widths corresponding to a plurality of accessible sections within the at least one accessible region;
a scale-determining unit, being to evaluate the plurality of accessible sectional widths to further derive a plurality of narrowed accessible sectional widths with respect to the plurality of accessible sections, wherein, the wider one of the plurality of accessible sectional widths is, the corresponding narrowed accessible sectional width is; and
an modified-map generating unit, being to amend the plurality of accessible sections on the regional map into a plurality of narrowed accessible sections according to the plurality of narrowed accessible sectional widths, so that the regional map is transformed into a modified map; and
a guiding module, connected communicatively with the modified mapping module and the local mapping module, being to guide the automated guided vehicle to pass through the plurality of narrowed accessible sections, after the present position and a target position are confirmed.

2. The automated guided vehicle of claim 1, wherein the guiding module includes an optimal-route planning unit for planning an optimal route for the automated guided vehicle to displace within the at least one narrowed accessible region, and the optimal route is one of a time-optimal route and a safety-optimal route.

3. The automated guided vehicle of claim 1, further including a speed-modulating module connected communicatively with the modified mapping module and the guiding module, the speed-modulating module being to generate a plurality of moving speeds with respect to the plurality of narrowed accessible sectional widths so as to control the automated guided vehicle to travel in the at least one narrowed accessible region at the moving speed corresponding to the respective narrowed accessible sectional width.

4. The automated guided vehicle of claim 1, wherein the regional mapping module includes a regional-map scanning unit for scanning the working area.

5. The automated guided vehicle of claim 4, wherein the regional-map scanning unit is a laser scan unit.

6. The automated guided vehicle of claim 1, wherein the local mapping module includes a local-map scanning unit for scanning the instant surrounding region in a real time manner.

7. The automated guided vehicle of claim 6, wherein the local-map scanning unit is a laser scan unit.

8. The automated guided vehicle of claim 1, wherein the local mapping module includes a map-to-map comparing unit for comparing a plurality of local characteristic points on the local map with a plurality of regional characteristic points on the regional map, so that, if the plurality of local characteristic points match the plurality of regional characteristic points, the present position of the automated guided vehicle is confirmed.

9. The automated guided vehicle of claim 1, wherein, in the case that one of the plurality of accessible sectional widths is larger than a predetermined width more than a width of the automated guided vehicle, the scale-determining unit assigns a predetermined narrowed width ranging 1/1000˜½ width of the automated guided vehicle to be removed from each one side of the one of the plurality of accessible sectional widths so as to form correspondingly one of the plurality of narrowed accessible sectional widths.

10. The automated guided vehicle of claim 1, further including an obstacle height-determining unit for capturing at least an image of a specific obstacle out of the at least one obstacle and further evaluating a height of the specific obstacle, the obstacle height-determining unit communicatively connected with the guiding module, the regional mapping module and the local mapping module; wherein, when the obstacle height-determining unit judges the specific obstacle to have a height lower than a predetermined traversable height for the automated guided vehicle, the obstacle height-determining unit defines the specific obstacle as a traversable obstacle and an area occupied by the specific obstacle as an extended accessible region.
